(19) United States
(12) Patent Application Publication
(10) Pub. No.: US 2025/0196497 A1
(43) Pub. Date: Jun. 19, 2025

(54) INKJET HEAD AND INKJET RECORDING DEVICE

(71) Applicant: Konica Minolta, Inc., Tokyo (JP)

(72) Inventors: Kazuya KINJO, Hino-shi, Tokyo (JP); Ryohei KOBAYASHI, Hino-shi, Tokyo (JP)

(21) Appl. No.: 18/844,301

(22) PCT Filed: Mar. 18, 2022
(86) PCT No.: PCT/JP2022/012681

§ 371 Date: Sep. 5, 2024

(51) Int. Cl. B41J 2/14; B41J 2/045

(52) U.S. Cl. CPC B41J 2/14233; B41J 2/04573; B41J 2/04581; B41J 2/04588; B41J 2/0459; B41J 2/04591

(57) ABSTRACT

An inkjet head includes: a pressure chamber filled with ink; an actuator that changes a pressure of the ink filling the chamber; a nozzle that ejects the ink filling the chamber by the actuator being driven; and a communication channel that supplies the ink to the chamber. The communication channel has a narrowed part having a cross-sectional area perpendicular to an ejection direction of the ink smaller than any other part in the communication channel. Q_{C} that is a Q factor in the chamber calculated by using 5.7 mPa·s as a viscosity of the ink, 1,080 kg/m³ as a density of the ink, and 1,521 m/s as a value of a speed of a sound transmitted through the ink satisfies Formula (1); Q_{C}≥0.0222Sᵣ−17.524, where Sᵣ represents, of the narrowed part, the cross-sectional area perpendicular to the ejection direction of the ink.

### TECHNICAL FIELD

The present invention relates to an inkjet head and an inkjet recording apparatus.

### BACKGROUND ART

In an inkjet recording apparatus, when ink is ejected from each nozzle of an inkjet head, a minute satellite droplet (a relatively long small droplet leading from a main droplet to the nozzle) is present in addition to the main droplet related to printing. There is a risk that the satellite droplet is separated from the main droplet and mist is generated from the separated satellite droplet. Since the separated satellite droplet or the generated mist lands on an unexpected part of the recording medium, there is a risk that the image quality of the image formed on the recording medium may deteriorate.

Therefore, there has been made an invention for suppressing deterioration in image quality of an image formed on a recording medium due to separated satellite droplets or generated mist.

In this regard, in Patent Literature 1, there is described providing a rectification plate having an opening through which ink ejected from an inkjet head passes to control a conveyance flow and suction air, thereby suppressing diffusion of satellite droplets.

Further, in Patent Literature 2, there is described suppressing decrease in the speed of satellite droplets by a drive waveform for driving an inkjet head, thereby stably ejecting ink.

### CITATION LIST

### Patent Literature

Patent Literature 1: Japanese Unexamined Patent Publication No. 2020-131645
Patent Literature 2: Japanese Unexamined Patent Publication No. 2020-082433

### SUMMARY OF INVENTION

### Technical Problem

By the way, if a media gap that is a distance between the surface of a recording medium and the nozzle surface of an inkjet head is large (for example, 10 to 20 mm), the range of printing objects can be expanded, for example, printing on a three-dimensional object becomes possible.

In the case where the media gap is large, in order to stably perform printing on a recording medium, it is necessary that the droplet speed of the ink is high and the droplet amount of the ink is large. However, if the droplet speed of the ink is high or the droplet amount of the ink is large, satellite droplets are likely to be generated, which may result in decrease in image quality.

In Patent Literatures 1 and 2, the case where the media gap is large is not assumed, and there is a possibility that suppression of satellite droplets is insufficient.

An object of the present invention is to provide an inkjet head and an inkjet recording apparatus that can further suppress satellite droplets and perform stable ejection.

### Solution to Problem

In order to achieve the above object, an inkjet head described in claim 1 includes:
a pressure chamber filled with ink;
an actuator that changes a pressure of the ink filling the pressure chamber;
a nozzle that ejects the ink filling the pressure chamber by the actuator being driven; and
a communication channel that supplies the ink to the pressure chamber,
wherein the communication channel has a narrowed part having a cross-sectional area perpendicular to an ejection direction of the ink smaller than any other part in the communication channel, and
wherein Q_{C} that is a Q factor in the pressure chamber calculated by using 5.7 mPa·s as a viscosity of the ink, 1,080 kg/m³ as a density of the ink, and 1,521 m/s as a value of a speed of a sound transmitted through the ink satisfies Formula (1) below:

$${Q}_{C} \geq 0.0222 {S}_{r} - 17. 524 , \qquad Formula ( 1 )$$

where Sᵣ represents, of the narrowed part, the cross-sectional area perpendicular to the ejection direction of the ink.

Further, the invention described in claim 2 is the inkjet head described in claim 1, wherein the nozzle has a substantially circular section perpendicular to the ejection direction of the ink, and has a tapered part having a cross-sectional area perpendicular to the ejection direction decreasing monotonically from a pressure chamber side where the pressure chamber is provided toward an ejection port side where an ejection port of the nozzle is provided.

Further, the invention described in claim 3 is the inkjet head described in claim 1,
wherein the nozzle has a funnel part and a tapered part,
wherein the funnel part has a substantially circular section perpendicular to the ejection direction of the ink, and has a cross-sectional area perpendicular to the ejection direction decreasing monotonically from a pressure chamber side where the pressure chamber is provided toward an ejection port side where an ejection port of the nozzle is provided, and
wherein the tapered part is disposed closer to the ejection port than the funnel part is in the ejection direction, has a substantially circular section perpendicular to the ejection direction, has a cross-sectional area perpendicular to the ejection direction decreasing monotonically toward the ejection direction, and has an inclination of the decrease in the cross-sectional area smaller than an inclination of the decrease in the cross-sectional area of the funnel part perpendicular to the ejection direction.

The invention described in claim 4 is the inkjet head described in claim 3,
wherein a taper angle of the funnel part is 40 degrees or more and 50 degrees or less, and
wherein a taper angle of the tapered part is 3 degrees or more and 12 degrees or less.

The invention described in claim 5 is the inkjet head described in any one of claims 2 to 4,
wherein the nozzle has a straight part disposed closer to the ejection port than the tapered part is in the ejection direction, and
wherein the straight part has a substantially circular section perpendicular to the ejection direction, and has a cross-sectional area perpendicular to the ejection direction not changing.

The invention described in claim 6 is the inkjet head described in any one of claims 1 to 5 including nozzle rows in each of which nozzles each being the nozzle are arranged one dimensionally in a predetermined nozzle arrangement direction,
wherein the nozzle rows are arranged such that the nozzles of the nozzle rows are at same positions in a direction perpendicular to a relative movement direction with respect to a recording medium at a time when drawing is performed while the ink is ejected from the nozzles.

The invention described in claim 7 is the inkjet head described in any one of claims 1 to 6 including:
the inkjet head according to any one of claims 1 to 6; and
a drive controller that drives the actuator,
wherein the drive controller drives the actuator such that a droplet speed of the ink at a position of 0.5 mm in the ejection direction of the ink from the ejection port of the nozzle is 7 m/s or more.

The invention described in claim 8 is the inkjet head described in claim 7, wherein in a case where the droplet speed at the position of 0.5 mm in the ejection direction from the ejection port is 7 m/s, the drive controller drives the actuator by using a simple pull-and-strike waveform having a width of 1 AL such that a liquid measure of a droplet of the ink is 2 pL or more and 4 pL or less.

The invention described in claim 9 is the inkjet head described in claim 7 or 8,
wherein the drive controller drives the actuator by a drive waveform having a first expansion portion, a second expansion portion and a third expansion portion that expand a volume of the pressure chamber and a first contraction portion and a second contraction portion that contract the volume of the pressure chamber, and
wherein in the drive waveform, a time from a start point of the second expansion portion to a start point of the second contraction portion is shorter than a time from a start point of the first expansion portion to a start point of the first contraction portion.

The invention described in claim 10 is the inkjet head described in claim 9, wherein in the drive waveform, the first contraction portion is started 0.7 AL to 1.2 AL after the start point of the first expansion portion, the second expansion portion is started 0.4 AL to 0.6 AL after the start point of the first contraction portion, the second contraction portion is started 0.3 AL to 0.6 AL after the start point of the second expansion portion, and the third expansion portion is started 0.8 AL to 1.2 AL after the start point of the second contraction portion.

The invention described in claim 11 is the inkjet head described in claim 10, wherein in the drive waveform, the first contraction portion is started 0.7 AL to 0.9 AL after the start point of the first expansion portion.

The invention described in claim 12 is the inkjet head described in any one of claims 9 to 11,
wherein the drive controller drives the actuator by a composite drive waveform including a first drive waveform and a second drive waveform applied after the first drive waveform,
wherein the first drive waveform and the second drive waveform each have the first expansion portion, the second expansion portion, the first contraction portion and the second contraction portion, and
wherein a voltage amplitude of the second contraction portion in the second drive waveform is larger than a voltage amplitude of the second contraction portion in the first drive waveform.

The invention described in claim 13 is the inkjet head described in claim 12, wherein the composite drive waveform includes, before the first drive waveform being initial, a vibration waveform that vibrates a liquid surface of the ink in the nozzle.

The invention described in claim 14 is the inkjet head described in any one of claims 7 to 13, wherein the drive controller drives the actuator such that a distance t_{gap} from the ejection port of the nozzle to a recording medium and a volume V_{drop} of a droplet of the ink satisfy Formula (2) below:

$${t}_{gap} \leq - 4.81 {{e}^{- 6} ( {V}_{drop} )}^{4} + 7.45 {{e}^{- 4} ( {V}_{drop} )}^{3} - 4.50 {{e}^{- 2} ( {V}_{drop} )}^{2} + 1.79 {V}_{drop} + 2 \text{.90} . \qquad Formula ( 2 )$$

### Advantageous Effects of Invention

According to the present invention, satellite droplets can be further suppressed and stable ejection can be performed.

### BRIEF DESCRIPTION OF DRAWINGS

FIG. 1 This is a block diagram illustrating a functional configuration of an inkjet recording apparatus.

FIG. 2 This is a diagram illustrating a schematic configuration of the inkjet recording apparatus.

FIG. 3 This is a schematic diagram illustrating a configuration of a head unit.

FIG. 4 This is a perspective view illustrating a configuration of an inkjet head.

FIG. 5 This is a diagram illustrating a configuration of a head chip included in the inkjet head.

FIG. 6 This is an enlarged view of an end of the head chip on the positive side in the X-axis direction.

FIG. 7 This is a sectional view taken along line VII-VII in FIG. 6.

FIG. 8A This is a diagram illustrating the shape of a nozzle.

FIG. 8B This is a diagram illustrating the shape of a nozzle.

FIG. 8C This is a diagram illustrating the shape of a nozzle.

FIG. 8D This is a diagram illustrating the shape of a nozzle.

FIG. 9 This is a diagram illustrating satellite characteristics.

FIG. 10A This is a diagram schematically showing an example of arrangement of openings in a nozzle opening surface.

FIG. 10B This is a diagram illustrating an example of droplets landed on a recording medium in the case of FIG. 9A.

FIG. 11A This is a diagram schematically illustrating an example of arrangement of openings in a nozzle opening surface.

FIG. 11B This is a diagram illustrating an example of droplets landed on a recording medium in the case of FIG. 10A.

FIG. 12 This is a diagram illustrating a simple pull-and-strike waveform having a width of 1 AL.

FIG. 13A This is a view of forming a large droplet by overlapping a plurality of small droplets.

FIG. 13B This is a view of ejecting one large droplet.

FIG. 14 This is a view illustrating an example of a drive waveform.

FIG. 15A This is a diagram showing a drive period characteristic of the droplet speed when the simple pull-and-strike waveform having a width of 1 AL is used.

FIG. 15B This is a diagram showing a drive period characteristic of the droplet speed when the drive waveform shown in FIG. 14 is used.

FIG. 16 This is a diagram illustrating an example of the drive waveform.

FIG. 17 This is a diagram illustrating an example of a composite drive waveform.

### DESCRIPTION OF EMBODIMENTS

Hereinafter an embodiment(s) of an inkjet head and an inkjet recording apparatus of the present invention will be described with reference to the drawings.

### <Configuration of Inkjet Recording Apparatus>

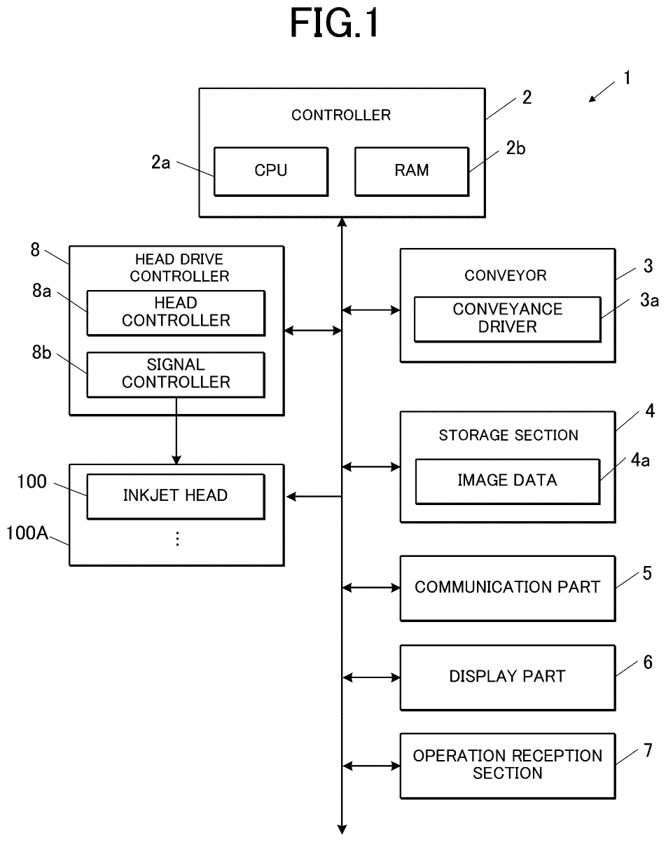

FIG. 1 is a block diagram illustrating a functional configuration of an inkjet recording apparatus 1.

The inkjet recording apparatus 1 according to the present embodiment includes a controller 2, a conveyor 3, a storage section 4, a communication part 5, a display part 6, an operation reception section 7, a head drive controller 8 (drive controller), and a head unit 100A including a plurality of inkjet heads 100.

The controller 2 includes a CPU 2a that performs arithmetic processing, a RAM 2b that provides a working memory space for the CPU 2a and stores temporary date, and the like, and comprehensively controls the operation of the inkjet recording apparatus 1.

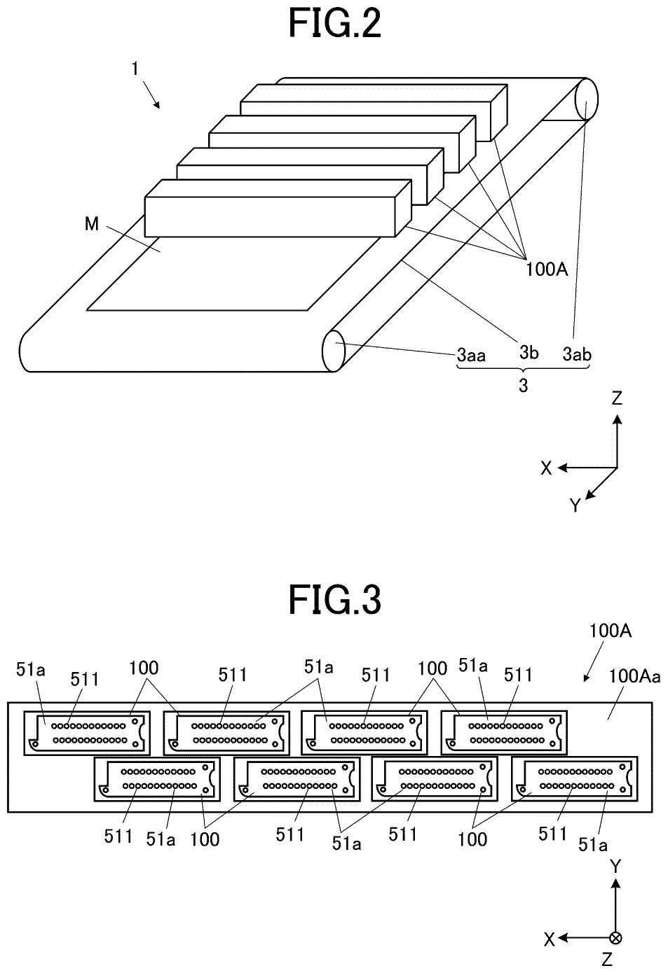

FIG. 2 is a diagram illustrating a schematic configuration of the inkjet recording apparatus 1.

The conveyor 3 moves a recording medium M, on which an image or the like is to be recorded by the inkjet recording apparatus 1, relative to the ink ejection face of the inkjet head 100 while the recording medium M faces the ink ejection face. The conveyor 3 includes a conveyance driver 3a.

The conveyance driver 3a includes, for example, two conveyance rollers 3aa and 3ab that rotate on rotation axes extending in the X-axis direction of FIG. 2. The conveyance rollers 3aa and 3ab support the inner side of a ring-shaped conveyance belt 3b.

In a state where the recording medium M is placed on the conveyance surface of the conveyance belt 3b, the conveyance driver 3a rotates the conveyance roller 3aa in response to operation of a not-shown conveyance motor to move the conveyance belt 3b in a circulating manner, thereby conveying the recording medium M in a movement direction of the conveyance belt 3b (conveyance direction; a Y-axis direction in FIG. 2).

The recording medium M may be a flat sheet cut into a certain size. The recording medium M is supplied onto the conveyance belt 3b by a not-shown sheet feed device, and is ejected from the conveyance belt 3b to a predetermined sheet ejection section after ink is ejected from the head unit 100A and an image is recorded. Note that a long recording medium such as a roll sheet or a continuous sheet may be used as the recording medium M. As the recording medium M, in addition to paper such as plain paper or coated paper, various media can be used onto which ink having landed on the surface can be fixed, such as cloth or sheet-like resin.

The storage section 4 stores programs related to operation control, setting data, and the like. The storage section 4 includes a nonvolatile memory and/or a hard disk drive (HDD). Furthermore, the storage section 4 may be capable of storing image data 4a to be recorded acquired from the outside via the communication part 5, processed data thereof, and the like. For storage of these data, the storage section 4 may include a volatile memory such as a DRAM.

The communication part 5 controls communication with external devices to transmit and receive data. The communication part 5 includes, for example, a network card and controls data communication on the basis of a communication standard such as TCP/IP using a LAN. The external devices to be connected include various computer terminals that output an image recording instruction and the image data 4a to be recorded.

The display part 6 performs various types of display on the display screen based on the control of the controller 2. Examples of the display screen includes a liquid crystal display. The display screen includes performing, for example, display of a status related to the image recording operation and display of a setting selection screen. The display part 6 may include an LED lamp and the like, and may be capable of providing notification of, for example, whether or not power is supplied from the main power source, and/or whether or not an abnormal state of the status exists.

The operation reception section 7 receives an input operation from the outside, such as a user, and outputs the input operation as an input signal to the controller 2. As the operation reception section 7, for example, a touch screen provided to be superimposed on the display screen is exemplified. The operation reception section 7 may also include a push button switch and/or a rotary switch.

The head drive controller 8 outputs, at an appropriate timing according to each piece of pixel data of an image to be recorded, a drive voltage signal for obtaining a drive signal for driving an actuator 30, which will be described later, of the inkjet head 100. The head drive controller 8 may be collectively formed on a substrate or the like, or may be disposed in a distributed manner in each part of the inkjet recording apparatus 1. In addition, part or all of the configuration of the head drive controller 8 may be included in the inkjet head 100. The head drive controller 8 includes a head controller 8a and a signal controller 8b.

The head controller 8a includes a CPU and a storage section, and controls the operation of the head drive controller 8 according to the presence or absence of the image data 4a to be recorded and the content of the image data 4a. In the storage section, data of a waveform pattern of a drive signal for ejecting ink from a nozzle(s) 51 (see FIG. 7) or vibrating a liquid surface (meniscus) of ink in the nozzle 51 is held in advance.

The signal controller 8b outputs, to the inkjet head 100, the waveform signal (input signal) acquired from the head controller 8a at an appropriate timing corresponding to a not-shown clock signal (synchronization signal). A plurality of types of waveform pattern of the drive signal may be held, and the waveform patterns may be switched in and at predetermined order and timing.

The head unit 100A records an image by ejecting ink onto the recording medium M conveyed by the conveyor 3 at an appropriate timing based on the image data 4a. In the inkjet recording apparatus 1 of the present embodiment, four head units 100A respectively corresponding to four color inks of yellow (Y), magenta (M), cyan (C), and black (K) are arranged at predetermined intervals in the order of Y, M, C, and K from the upstream side in the conveyance direction of the recording medium M. The number of head units 100A may be three or less or five or more.

FIG. 3 is a schematic diagram illustrating a configuration of the head unit 100A, and is a plan view of the head unit 100A when viewed from a side facing a conveyance surface of the conveyance belt 3b. The head unit 100A includes a plate-shaped base 100Aa, and a plurality of (here, eight) inkjet heads 100 fixed to the base 100Aa in a state of being fitted in through holes provided in the base 100Aa. The inkjet head 100 is fixed to the base 100Aa in a state in which a nozzle opening surface 51a provided with openings 511 (ejection ports) of nozzles 51 is exposed from a through hole of the base 100Aa in the Z-axis negative direction.

In the inkjet head 100, the openings 511 of the nozzles 51 are arranged at equal intervals in a direction intersecting the conveyance direction of the recording medium M (in the present embodiment, the width direction perpendicular to the conveyance direction, that is, the X axis direction). That is, each inkjet head 100 has a row(s) (nozzle row(s)) of nozzles 51 arranged one dimensionally at equal intervals in the X-axis direction.

Note that in the example illustrated in FIG. 3, the inkjet head 100 has two nozzle rows.

The eight inkjet heads 100 in the head unit 100A are arranged in a houndstooth check pattern such that arrangement areas of the nozzles 51 in the X-axis direction are continuous. The arrangement areas of the nozzles 51 included in the head unit 100A in the X-axis direction cover the width in the X-axis direction of an image recordable region in the recording medium M conveyed by the conveyance belt 3b.

The head unit 100A is used while its position is fixed during recording of an image, and records an image by a single-pass method by ejecting ink from the nozzles 51 to positions at predetermined intervals in the conveyance direction (intervals in the conveyance direction) as the recording medium M is conveyed.

### <Configuration of Inkjet Head>

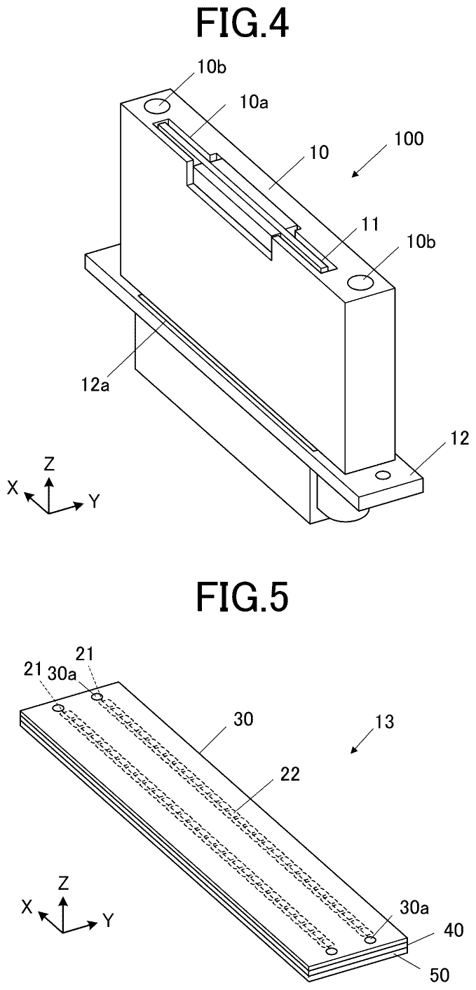

FIG. 4 is a perspective view illustrating a configuration of the inkjet head 100.

FIG. 5 is a diagram illustrating a configuration of a head chip 13 included in the inkjet head 100.

As illustrated in FIG. 4, the inkjet head 100 includes a housing 10 and a head base 12. The housing 10 is attachable to and detachable from the head base 12.

The housing 10 is a rectangular box whose lower surface (surface on the negative side in the Z-axis direction) is opened. A notch 10a that leads to the inside is provided in the upper surface (surface on the positive side in the Z-axis direction) of the housing 10, and a circuit board 11 is housed in the housing 10 via the notch 10a. A drive circuit for driving the actuator 30 in the head chip 13 is mounted on the circuit board 11. Circular holes 10b are provided on the X-axis direction positive side and the X-axis direction negative side of the notch 10a. The holes 10b are for guiding a not-shown ink supplying tube(s) into the housing 10.

The head base 12 is a frame having, at its center, a rectangular opening 12a that penetrates vertically. The head chip 13 shown in FIG. 5 is provided at the lower end of the opening 12a. The circuit board 11 and a not-shown flexible printed circuit (FPC) are electrically connected to the head chip 13 in the opening 12a.

As shown in FIG. 5, the head chip 13 has a configuration in which an actuator 30, a channel substrate 40, and a nozzle substrate 50 are stacked in this order. The actuator 30, the channel substrate 40, and the nozzle substrate 50 are rectangular parallelepiped plates and have the same shape when viewed from the Z-axis direction. The actuator 30 and the channel substrate 40 are bonded to each other via an adhesive. Further, the channel substrate 40 and the nozzle substrate 50 are bonded to each other via an adhesive.

Two supply channels 21 extending in the X-axis direction are formed in the channel substrate 40.

Two ink supply ports 30a are formed side by side in the Y-axis direction at the end on the positive side in the X-axis direction and the end on the negative side in the X-axis direction of the actuator 30. Each ink supply port 30a is connected to one supply channel 21.

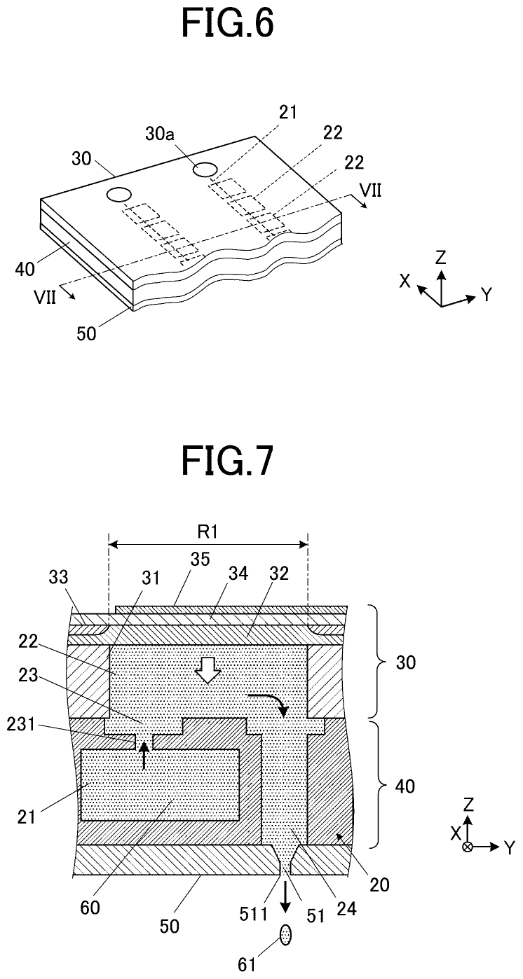

FIG. 6 is an enlarged view of the end of the head chip 13 on the positive side in the X-axis direction.

In the actuator 30, a plurality of pressure chambers 22 is provided along the supply channels(s) 21. Specifically, grooves are formed at positions corresponding to the pressure chambers 22 on the lower surface (surface on the negative side in the Z axis direction) of the actuator 30, and the pressure chambers 22 are formed between the grooves of the lower surface of the actuator 30 and the upper surface (surface on the positive side in the Z axis direction) of the channel substrate 40 by the actuator 30 being superposed on the channel substrate 40. The pressure chambers 22 are connected to the supply channels 21 via supply-side communication channels 23 (communication channels) (see FIG. 7) formed in the channel substrate 40.

A terminal group (not illustrated) for connecting the FPC of the circuit board 11 is provided at each of the end on the negative side in the Y-axis direction and the end on the positive side in the Y-axis direction of the upper surface (surface on the positive side in the Z-axis direction) of the actuator 30. This terminal group is for applying a voltage (drive signal) to a piezoelectric layer 34 (see FIG. 7) of the actuator 30.

As described above, the ends of the supply channels 21 are connected to the ink supply ports 30a. A large number of pressure chambers 22 are disposed along the supply channel(s) 21, and each pressure chamber 22 is connected to the supply channel 21 by the supply-side communication channel 23.

Returning to FIG. 5, a not-shown ink supply tube is connected to each of the four ink supply ports 30a, and ink is supplied from the ink supply tube. The ink supplied to the ink supplying port 30a is supplied to the pressure chamber 22 through the supply channel 21 and the supply-side communication channel 23. In the present embodiment, ink of the same color is supplied to two supply channels 21. However, this is not a limitation, and inks of different colors may be supplied to the respective supply channels 21 so that the inks of two colors can be ejected by one inkjet head 100.

FIG. 7 is a sectional view taken along line VII-VII in FIG. 6.

The channel substrate 40 is formed of, for example, a stainless steel (SUS) material or 42 alloy, but is not limited thereto.

The actuator 30 is bonded to the upper surface (surface on the positive side in the Z-axis direction) of the channel substrate 40 via an adhesive. The nozzle substrate 50 is bonded to the lower surface (surface on the negative side in the Z-axis direction) of the channel substrate 40 via an adhesive.

As illustrated in FIG. 7, the supply channel 21, the supply-side communication channel 23, and the nozzle-side communication channel 24 are provided in the channel substrate 40.

The supply-side communication channel 23 extends from the Z-axis direction positive side of the supply channel 21 and is connected to the pressure chamber 22. Further, the supply-side communication channel 23 has a narrowed part 231 whose cross-sectional area perpendicular to the Z-axis direction is smaller than that of any other part in the supply-side communication channel 23.

The nozzle-side communication channel 24 passes through the channel substrate 40 so as to connect the pressure chamber 22 and the nozzle 51 of the nozzle substrate 50.

The supply-side communication channel 23, the pressure chamber 22, the nozzle-side communication channel 24, and the nozzle 51 constitute an ink ejection channel 20.

The material of the nozzle substrate 50 is not particularly limited, but is, for example, metal or resin.

In the nozzle substrate 50, the nozzle 51 penetrating the nozzle substrate 50 is formed at a position corresponding to the nozzle-side communication channel 24 extending from the pressure chamber 22 in the Z-axis negative direction.

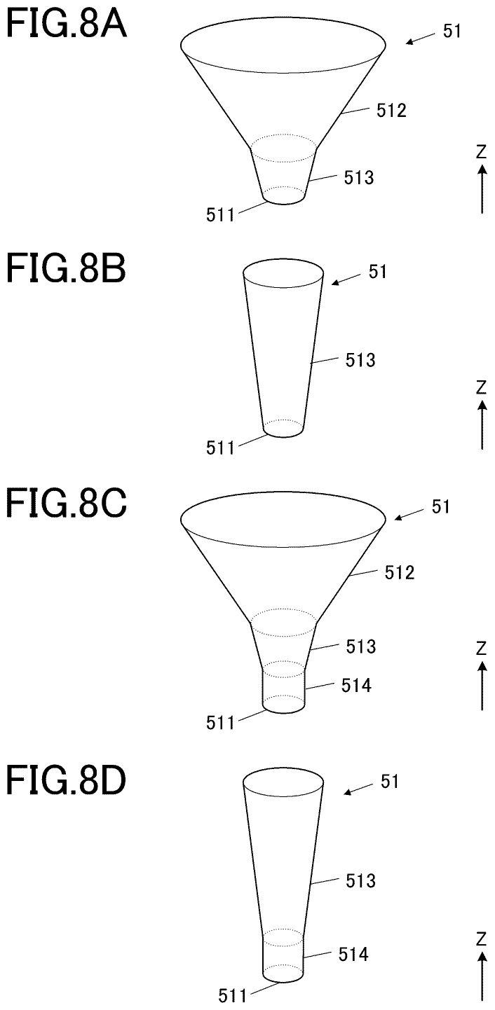

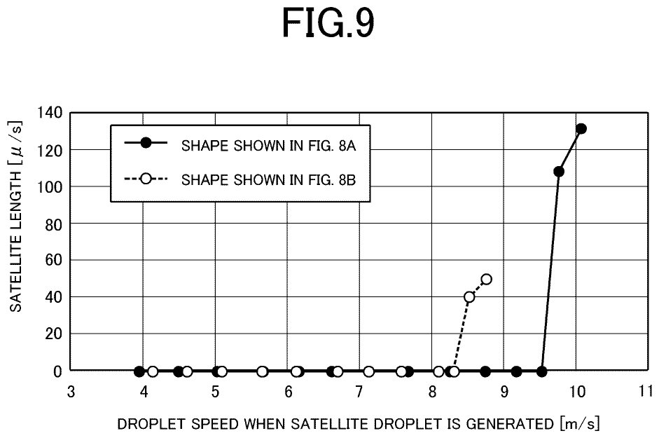

FIG. 8A is a view illustrating the shape of the nozzle 51.

As illustrated in the FIG. 8A, the nozzle 51 has a funnel part 512 and a tapered part 513.

The funnel part 512 has a substantially circular section perpendicular to the Z-axis direction (ejection direction), and the cross-sectional area perpendicular to the Z-axis direction decreases monotonically from the pressure chamber 22 side where the pressure chamber is provided toward the opening 511 side where the opening 511 is provided (from the positive side to the negative side in the Z-axis direction).

The taper angle of the funnel part 512 is 40 degrees or more and 50 degrees or less.

The tapered part 513 is located closer to the opening 511 (the negative side in the Z-axis direction) than the funnel part 512 is. The tapered part 513 has a substantially circular section perpendicular to the Z-axis direction, and the cross-sectional area perpendicular to the Z-axis direction decreases monotonically from the positive side toward the negative side in the Z-axis direction, and inclination of decrease of the cross-sectional area is smaller than that of the funnel part 512.

The tapered part 513 has a taper angle of 3 degrees or more and 12 degrees or less.

The nozzle 51 may have a shape illustrated in FIGS. 8B to 8D.

In the case of the nozzle 51 illustrated in FIG. 8B, the nozzle 51 as a whole is the tapered part 513. That is, the nozzle 51 has a substantially circular section perpendicular to the Z axis direction (ejection direction), and the cross-sectional area perpendicular to the Z-axis direction decreases monotonically from the pressure chamber 22 side toward the opening 511 side (from the positive side to the negative side in the Z-axis direction).

The nozzle 51 illustrated in FIG. 8C has the funnel part 512, the tapered part 513, and a straight part 514.

The straight part 514 has a substantially circular section perpendicular to the Z-axis direction, and is located closer to the opening 511 (negative side in the Z-axis direction) than the tapered part 513 is. The cross-sectional area of the straight part 514 perpendicular to the Z-axis direction does not change.

The nozzle 51 illustrated in FIG. 8D has the tapered part 513 and the straight part 514.

FIG. 9 illustrates satellite characteristics in the case where the nozzle 51 has the shape illustrated in FIG. 8A and in the case where the nozzle 51 has the shape illustrated in FIG. 8B. The horizontal axis in FIG. 9 represents the droplet speed [m/s] of droplets 61 when satellite droplets are generated, and the vertical axis represents the satellite length [μm] which is the length of the satellite droplet(s) in the Z-axis direction (ejection direction).

In the example illustrated in FIG. 9, the nozzle 51 having the shape illustrated in FIG. 8A includes the funnel part 512 having a taper angle of 45 degrees and the tapered part 513 having a taper angle of 9 degrees. The nozzle 51 having the shape illustrated in FIG. 8B includes the tapered part 513 having a taper angle of 9 degrees.

As illustrated in FIG. 9, the droplet speed of the droplet 61 when the satellite droplet is generated is higher and satellite performance is better in the case where the nozzle 51 has the shape illustrated in FIG. 8B than in the case where the nozzle 51 has the shape illustrated in FIG. 8A. Therefore, it is desirable that the nozzle 51 has the shape (having the funnel part 512 and the tapered part 513) illustrated in FIG. 8A.

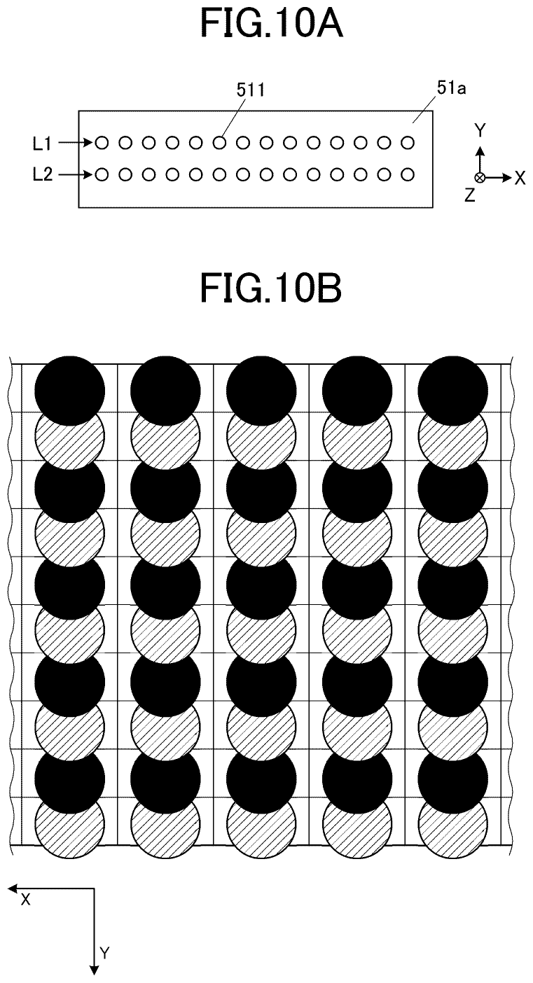

FIG. 10A is a diagram schematically illustrating arrangement of the openings 511 in the nozzle opening surface 51a of the nozzle substrate 50.

As illustrated in FIG. 10A, the openings 511 (nozzles 51) are arranged in the nozzle opening surface 51a of the nozzle substrate 50 so as to form rows. Two rows L1 and L2 of the nozzles 51 are arranged in the nozzle substrate 50. For example, several hundred nozzles 51 are provided at regular intervals in each of the rows L1 and L2.

The number of nozzles 51 in each row is not limited to this. In addition, three or more nozzle rows may be provided.

In the present embodiment, as illustrated in FIG. 10A, the rows L1 and L2 are provided in a positional relationship in which the positions of the nozzles 51 in the X-axis direction are the same. That is, the nozzle rows (rows L1 and L2) are arranged such that the nozzles of the nozzle rows are at the same position(s) in the direction (X-axis direction) perpendicular to the relative movement direction (Y-axis direction) with respect to the recording medium M of when drawing is performed while the ink 60 is ejected from the nozzles 51.

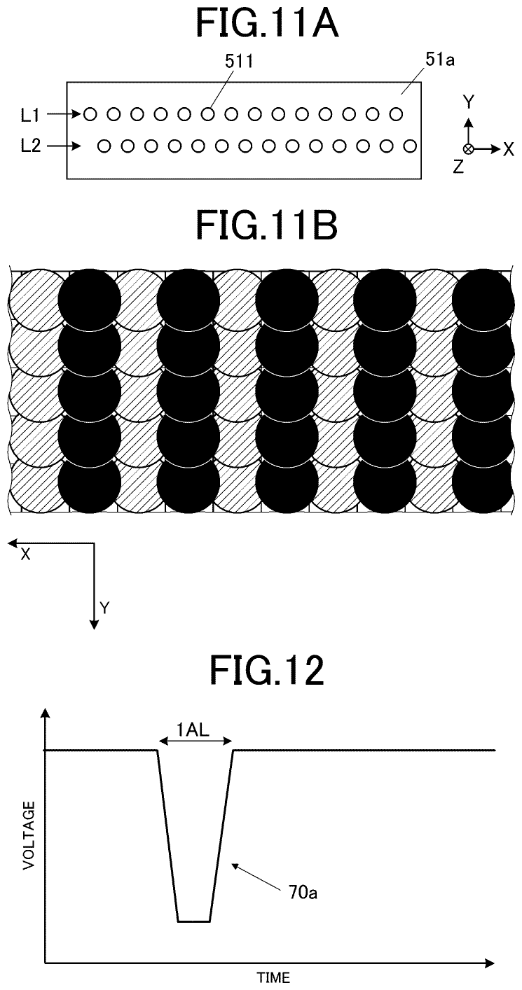

Contrary to FIG. 10A, in FIG. 11A, the rows L1 and L2 are provided in a positional relationship in which the positions of the nozzles 51 in the X-axis direction are shifted from each other.

FIG. 10B shows the result of landing of the droplets 61 on the recording medium M when the droplets 61 (see FIG. 7) are ejected five times from each of the rows L1 and L2 in the case of the configuration shown in FIG. 10A. FIG. 11B shows the result of landing of the droplets 61 on the recording medium M when the droplets 61 are ejected five times from each of the rows L1 and L2 in the case of the configuration shown in FIG. 11A.

In the example illustrated in FIGS. 10B and 11B, circles having oblique rows therein are results of landing of droplets 61 ejected from the row L1, and black circles are results of landing of droplets 61 ejected from the row L2.

As illustrated in FIGS. 10B and 11B, as compared with the configuration shown in FIG. 11A, the configuration shown in FIG. 10A can make the droplets 61 land in a wider area in the Y-axis direction (movement direction of the recording medium M) when the droplets 61 are ejected the same number of times. That is, productivity of the inkjet recording apparatus 1 can be improved.

Returning to FIG. 7, the actuator 30 has a pressure chamber layer 31 where the pressure chamber 22 is formed, and a vibration plate 32, an insulating layer 33, a piezoelectric layer 34 and an electrode layer 35 which are stacked on the upper part (Z-axis direction positive side) of the pressure chamber layer 31.

The vibration plate 32, the insulating layer 33, the piezoelectric layer 34, and the electrode layer 35 can be formed by a vacuum film forming technique such as a sputtering method. These layers may be formed by another film forming technique such as coating.

The pressure chamber layer 31 can be formed by a thick film forming technique such as a plating method or an etching method of a metal plate. The pressure chamber 22 is formed by bonding the channel substrate 40 to the lower surface (surface on the negative side in the Z-axis direction) of the pressure chamber layer 31.

The vibration plate 32 is made of a conductive metal material and serves as a lower electrode (common electrode) of the piezoelectric layer 34 too.

The insulating layer 33 insulates the vibration plate 32 from the piezoelectric layer 34. That is, the insulating layer 33 blocks voltage application to the piezoelectric layer 34 other than the piezoelectric functional region R1.

The piezoelectric layer 34 is formed of, for example, lead zirconate titanate (PZT). The film thickness of the piezoelectric layer 34 is about several μm.

The electrode layer 35 is formed of a conductive material. The electrode layer 35 is formed of, for example, titanium containing a noble metal. The film thickness of the electrode layer 35 is about 0.2 μm.

When a voltage is applied to the electrode layer 35, the piezoelectric layer 34 deforms in the Z-axis direction in the piezoelectric functional region R1, and accordingly the vibration plate 32 deforms. When the vibration plate 32 deforms downward (in the Z-axis negative direction) in the piezoelectric functional region R1, the volume of the pressure chamber 22 decreases (contracts), and the pressure of the ink 60 filling the pressure chamber 22 increases. When the vibration plate 32 deforms upward (in the Z-axis positive direction) in the piezoelectric functional region R1, the volume of the pressure chamber 22 increases (expands), and the pressure of the ink 60 filling the pressure chamber 22 decreases. By fluctuating the pressure of the ink 60 in a predetermined order (for example, by applying pressure after decompression), the droplet 61 of the ink 60 is ejected from the nozzle 51 which communicates with the pressure chamber 22 via the nozzle-side communication channel 24.

Each of the pressure chamber layer 31, the vibration plate 32, the insulating layer 33, the piezoelectric layer 34, and the electrode layer 35 is not necessarily a single layer, and may be formed of a plurality of layers. Further, another layer may be disposed between the layers.

### <Configuration of Ink Ejection Channel>

In the present embodiment, the ink ejection channel 20 is configured as follows.

Here, the series sum of inertance of the nozzle 51, inertance of the nozzle-side communication channel 24, and inertance on the downstream side (nozzle-side communication channel 24 side) from the center in the pressure chamber 22 is L1.

In addition, the series sum of inertance on the upstream side (supply-side communication channel 23 side) from the center in the pressure chamber 22 and inertance of the supply-side communication channel 23 is L2.

In addition, the series sum of channel resistance of the nozzle 51, channel resistance of the nozzle-side communication channel 24, and channel resistance on the downstream side (nozzle-side communication channel 24 side) from the center in the pressure chamber 22 is R1.

In addition, the series sum of channel resistance on the upstream side (supply-side communication channel 23 side) from the center in the pressure chamber 22 and channel resistance of the supply-side communication channel 23 is R2.

In addition, the parallel sum of compliance of the ink 60 in the pressure chamber 22 and mechanical compliance of the vibration plate 32 is C.

At the time, Q, which is a Q factor (indicator of how easily vibration attenuates) in the pressure chamber 22, is expressed by Formula (1) below.

$$Q = ( {L}_{all} \times π ) / ( {R}_{all} \times T / 2 ) \qquad Formula ( 1 )$$

Lₐₗₗ in the above Formula (1) is represented by Formula (2) below.

$${L}_{all} = ( {L}_{1} \times {L}_{2} ) / ( {L}_{1} + {L}_{2} ) \qquad Formula ( 2 )$$

Rₐₗₗ in the above Formula (1) is represented by Formula (3) below.

$${R}_{all} = ( {R}_{1} \times {R}_{2} ) / ( {R}_{1} + {R}_{2} ) \qquad Formula ( 3 )$$

T in the above Formula (1) is represented by Formula (4) below.

$$T = 2 π \times {( {L}_{all} \times C )}^{1 / 2} \qquad Formula ( 4 )$$

As Q is larger, reverberant vibration (vibration after ejection of the droplet 61) of the pressure chamber 22 is less likely to attenuate, and the satellite performance is better.

Since the Q factor varies depending on not only the shape design of the inkjet head but also the physical properties of the ink, it is preferable to make discussion using a value calculated with a specific ink.

Here, the ink ejection channel 20 is configured such that Q_{C} calculated in the case where ink having a viscosity of 5.7 [mPa·s], a density of 1,080 [kg/m³], and a value of the speed of sound transmitted through the ink of 1,521 [m/s] is used as the ink 60 for calculation of the Q factor satisfies Formula (5) below.

$$Q c \geq 0.0222 {S}_{r} - 17.524 \qquad Formula ( 5 )$$

Sᵣ: cross-sectional area of the narrowed part 231 perpendicular to the Z-axis direction

The above Formula (5) defines that Q_{C} calculated using predetermined physical property values (viscosity, density, and value of the speed of sound transmitted through the ink) of ink satisfies the conditions, and the physical property values of ink actually used for ejection do not need to match the above physical property values.

The head drive controller 8 drives the actuators 30 of the inkjet head 100 having the ink ejection channel 20 configured to satisfy the above Formula (5) using a drive waveform 70a (see FIG. 12) which is a simple pull-and-strike waveform having a width of 1 AL. AL (Acoustic Length) Is ½ of the acoustic resonance cycle of the pressure wave in the pressure chamber 22, and is the pulse width at which the speed becomes maximum when the speed change is measured when the pulse width is changed with the crest value of the simple pull-and-strike waveform being constant.

In this case, the droplet speed of the droplet 61 at the time of satellite droplet generation at a position of 1 mm from the opening 511 in the Z-axis negative direction is 8 m/s or more.

Therefore, it is possible to suppress generation of the satellite droplet and to stably eject the ink.

### <Drive of Inkjet Head>

In the present embodiment, the head drive controller 8 drives the actuators 30 such that the droplet speed of the droplet 61 at a position of 0.5 mm from the opening 511 in the Z-axis negative direction is 7 m/s or more.

At the time, in the case where a media gap of 3 mm is set as a target, if the volume of the droplet 61 is equal to or larger than 1.2 pl, the droplet 61 can be made to land on the recording medium M.

If the media gap is large (e.g., 10 to 20 mm), the droplet amount of the ink 60 needs to be large in order to stably perform printing on the recording medium M.

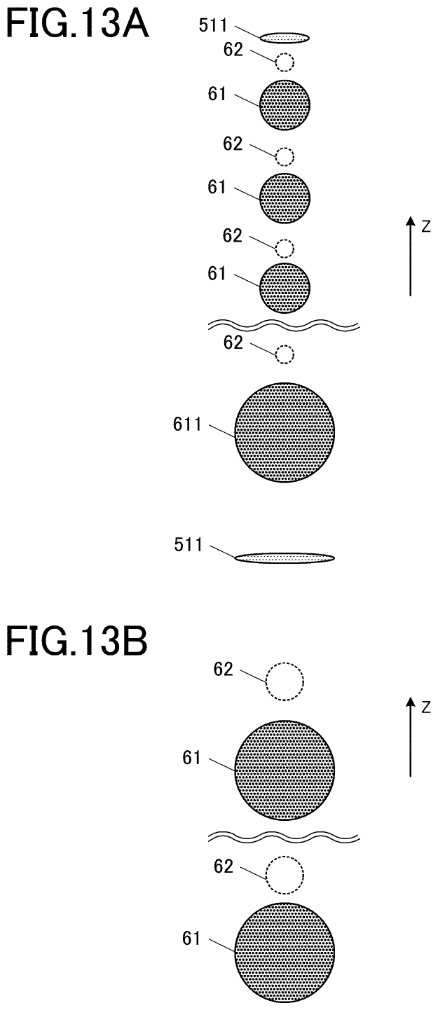

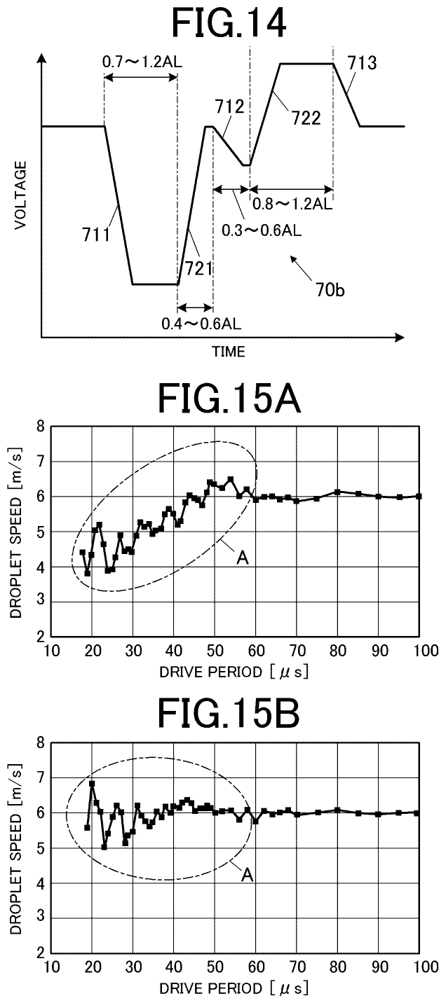

FIG. 13A is a diagram illustrating formation of a large droplet 611 by overlapping a plurality of droplets 61 which are small droplets, and FIG. 13B is a diagram illustrating ejection of only one droplet 61 which is a large droplet. In FIGS. 13A and 13B, the size of the satellite droplet 62 is proportional to the size of the droplet 61.

In the example shown in FIG. 13A, since the satellite droplet 62 is combined with the subsequent droplet 61, only the satellite droplet 62 associated with the finally ejected droplet 61 remains in the end. Therefore, as illustrated in FIG. 13A and FIG. 13B, the satellite droplet 62 in the case where a large droplet 611 is formed by overlapping droplets 61 as a plurality of small droplets is smaller than the satellite droplet 62 in the case where a droplet 61 that is a large droplet is ejected only once. That is, the satellite performance is better in the case where the large droplet 611 is formed by overlapping the droplets 61 which are a plurality of small droplets.

Therefore, in the present embodiment, it is preferable to use, as the inkjet head 100, an inkjet head designed such that the liquid measure of the droplet 61 is 2 pL or more and 4 pL or less when the droplet speed of the droplet 61 at a position of 0.5 mm in the Z-axis negative direction from the opening 511 is 7 m/s, using the simple pull-and-strike waveform having a width of 1 AL.

In this way, it is possible to form the large droplet 611 by overlapping the droplets 61 which are small droplets (2 pL or more and 4 pL or less) and to maintain good satellite performance even in the case where the media gap is large.

Further, in the present embodiment, the head drive controller 8 drives the actuators 30 using the waveform pattern (drive waveform 70b) of the drive signal shown in FIG. 14.

The drive waveform 70b illustrated in FIG. 14 has a first expansion portion 711, a second expansion portion 712, and a third expansion portion 713 which expand the volume of the pressure chamber 22, and a first contraction portion 721 and a second contraction portion 722 which contract the volume of the pressure chamber 22.

In the drive waveform 70b shown in FIG. 14, the first contraction portion 721 is started 0.7 AL to 1.2 AL after the start point of the first expansion portion 711. Then, the second expansion portion 712 is started 0.4 AL to 0.6 AL after the start point of the first contraction portion 721. Then, the second contraction portion 722 is started 0.3 AL to 0.6 AL after the start point of the second expansion portion 712. Then, the third expansion portion 713 is started 0.8 AL to 1.2 AL after the start point of the second contraction portion 722.

More preferably, in the drive waveform 70b, the first contraction portion 721 is started 0.7 AL to 0.9 AL after the start point of the first expansion portion 711. Thus, the drive time can be further shortened.

As described above, in the drive waveform 70b, the time (0.3 AL to 0.6 AL) from the start point of the second expansion portion 712 to the start point of the second contraction portion 722 is shorter than the time (0.7 AL to 1.2 AL) from the start point of the first expansion portion 711 to the start point of the first contraction portion 721. Thus, it is possible to prevent the droplet from being formed by the second expansion portion and the second contraction portion. In addition, it is possible to effectively pull back the droplet by the second expansion portion and the second contraction portion and to appropriately advance the meniscus in the nozzle 51.

FIG. 15A shows a drive period characteristic of the droplet speed of the droplet 61 in the case where the actuator 30 is driven using the simple pull-and-strike waveform having a width of 1 AL (drive waveform 70a). FIG. 15B shows a drive period characteristic of the droplet speed of the droplet 61 in the case where the actuator 30 is driven using the drive waveform 70b.

As illustrated in FIGS. 15A and 15B, in a high-speed drive region A in which the drive period is equal to or shorter than 60 μs, the droplet speed has a smaller speed fluctuation and is more stable in FIG. 15A than in FIG. 15B.

Therefore, by driving the actuator 30 using the drive waveform 70b, it is possible to perform stable high-speed driving.

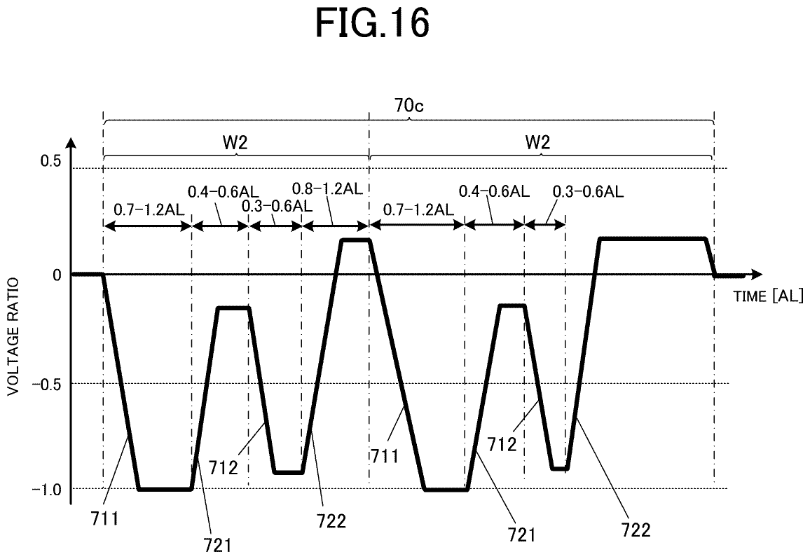

In the present embodiment, the head drive controller 8 drives the actuator 30 using the waveform pattern (drive waveform 70c) of the drive signal shown in FIG. 16.

The drive waveform 70c shown in FIG. 16 is a drive waveform to which the drive waveform 70b shown in FIG. 14 is applied, and forms the large droplet 611.

In FIG. 16, the drive waveform 70c is drawn with a potential ratio in the case where the reference potential is 0 and the lowest potential on the negative side is −1. The reference potential is a potential in a standby state in which the ink ejection operation is not performed.

The time axis is drawn with AL as a unit.

The drive waveform 70c shown in FIG. 16 includes two second drive waveforms W2 for ejecting the droplets 61 of the ink 60. The second drive waveform(s) W2 includes a first expansion portion 711, a second expansion portion 712, a first contraction portion 721, and a second contraction portion 722.

In addition, in the second drive waveform W2, similarly to the drive waveform 70b, the first contraction portion 721 is started 0.7 AL to 1.2 AL after the start point of the first expansion portion 711. Then, the second expansion portion 712 is started 0.4 AL to 0.6 AL after the start point of the first contraction portion 721. Then, the second contraction portion 722 is started 0.3 AL to 0.6 AL after the start point of the second expansion portion 712. Then, the second first expansion portion 711 is started 0.8 AL to 1.2 AL after the start point of the first second contraction portion 722. More preferably, in the second drive waveform W2, the first contraction portion 721 is started 0.7 AL to 0.9 AL after the start point of the first expansion portion 711.

By applying the drive waveform 70c shown in FIG. 16 to the piezoelectric layer 34, two droplets 61 ejected from the nozzle 51 can be made to coalesce and land on the recording medium M.

In the case where by driving the actuator 30 using the drive waveform 70c shown in FIG. 16, two droplets 61 are made to coalesce, and the droplet speed of the droplet 61 at a position of 0.5 mm in the Z-axis negative direction from the opening 511 is 7 m/s, the inkjet head 100 can eject the droplet 61 of about 4 to 8 pL. Therefore, by increasing the liquid measure (weight) of the droplet 61, it is possible to make the droplet 61 land at a further distant position.

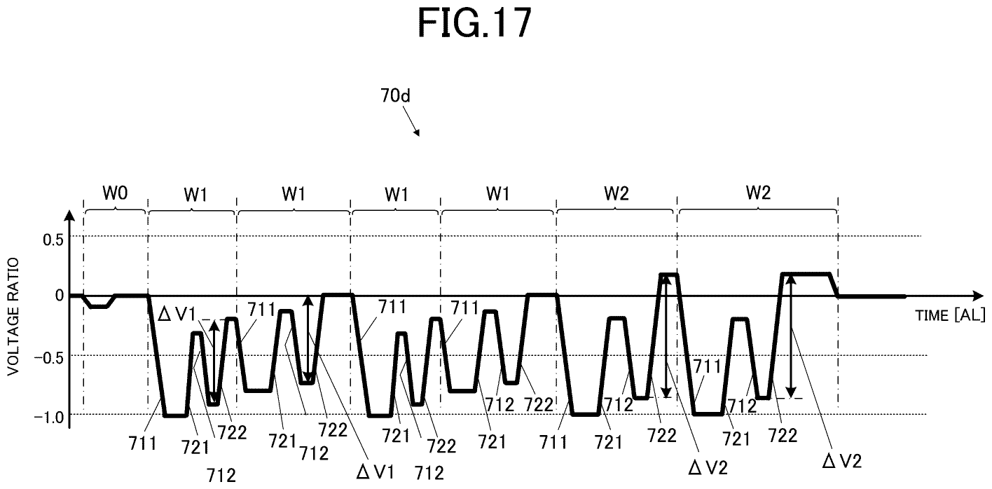

In the present embodiment, the head drive controller 8 drives the actuator 30 using the waveform pattern of the drive signal (composite drive waveform 70d) illustrated in FIG. 17.

The composite drive waveform 70d illustrated in FIG. 17 is a drive waveform in which the drive waveform 70b illustrated in FIG. 14 is further combined, and forms a larger droplet 611.

In FIG. 17, similarly to FIG. 16, the composite drive waveform WF is drawn with a potential ratio in the case where the reference potential is 0 and the lowest potential on the negative side is −1. The reference potential is a potential in a standby state in which the ink ejection operation is not performed.

The time axis is drawn with AL as a unit.

The composite drive waveform 70d shown in FIG. 17 includes a vibration waveform W0 which vibrates the liquid surface of the ink 60 in the nozzle 51, four first drive waveforms W1 which eject the droplets 61 of the ink 60, and two second drive waveforms W2 which are applied after the first drive waveforms W1 (hereinafter, either one of the first drive waveform(s) W1 and the second drive waveform(s) W2 is pointed, it is referred to as a “drive waveform Wn”).

Similarly to the second drive waveform W2, the first drive waveform W1 includes a first expansion portion 711, a second expansion portion 712, a first contraction portion 721, and a second contraction portion 722.

In addition, in the first drive waveform W1, similarly to the drive waveform 70b, the first contraction portion 721 is started 0.7 AL to 1.2 AL after the start point of the first expansion portion 711. Then, the second expansion portion 712 is started 0.4 AL to 0.6 AL after the start point of the first contraction portion 721. Then, the second contraction portion 722 is started 0.3 AL to 0.6 AL after the start point of the second expansion portion 712. More preferably, in the first drive waveform W1, the first contraction portion 721 is started 0.7 AL to 0.9 AL after the start point of the first expansion portion 711.

The composite drive waveform 70d shown in FIG. 17 includes six drive waveforms Wn, and by applying the composite drive waveform 70d to the piezoelectric layer 34, six droplets 61 of the ink 60 ejected from the nozzle 51 can be made to coalesce and land on the recording medium M. That is, six droplets 61 are ejected from the nozzle 51 in a state of being connected to be a columnar shape, and land on the recording medium M without being separated during flying.

Further, by vibrating the meniscus of the nozzle 51 by applying the vibration waveform W0 before the first application of the first drive waveform W1, it is possible to suppress fluctuation in the ejection characteristics of the ink due to drying (thickening) of the liquid surface of the ink.

Further, the voltage amplitude AV2 of the second contraction portion 722 in the second drive waveform W2 of the composite drive waveform 70d is larger than the voltage amplitude AV1 of the second contraction portion 722 in the first drive waveform W1. To be specific, in the example illustrated in FIG. 17, AV1 is 0.73, and AV2 is 1.1.

In order to secure this voltage amplitude AV2, the second contraction portion 722 is displaced to a potential exceeding the reference potential in the second drive waveform W2.

Thus, by increasing the voltage amplitude AV2, the ink 60 ejected by the first expansion portion 711 and the first contraction portion 721 is greatly accelerated by the contraction of the pressure chamber 22 corresponding to the second contraction portion 722. Therefore, it is possible to increase the speed of the droplet 61 of the ink 60 which is ejected by the second drive waveform W2, and to easily catch up with the droplet 61 of the ink 60 which is ejected earlier by the first drive waveform W1. The speed of the droplet 61 of the ink 60 ejected by the second drive waveform W2 is, for example, about 7 m/s.

In the case where by driving the actuator 30 using the composite drive waveform 70d shown in FIG. 17, six droplets 61 are made to coalesce, and the droplet speed of the droplet 61 at a position of 0.5 mm in the Z-axis negative direction from the opening 511 is 7 m/s, the inkjet head 100 can eject the droplet 61 of about 12 to 24 pL. Therefore, by increasing the liquid measure (weight) of the droplet 61, it is possible to make the droplet 61 land at a further distant position.

The drive waveforms illustrated in FIG. 16 and FIG. 17 are merely examples, and it is preferable to appropriately set a drive waveform according to the flying distance and the printing resolution.

In the present embodiment, the head drive controller 8 drives the actuator 30 to satisfy Formula (6) below.

$${t}_{gap} \leq {A ( {V}_{drop} )}^{4} + {B ( {V}_{drop} )}^{3} + {C ( {V}_{drop} )}^{2} + {DV}_{drop} + E \qquad Formula ( 6 )$$

t_{gap}: Distance from the opening 511 to the recording medium M
V_{drop}: Volume of the droplet 61
A: −4.81e⁻⁶
B: 7.45e⁻⁴
C: −4.50e⁻²
D: 1.79
E: 2.90

In this case, the droplet speed of the droplet 61 at the time of reaching the recording medium M is 0.01 [m/s] or more, and the droplet 61 can be made to land on the recording medium M even when the medium gap is large.

Preferably, the head drive controller 8 drives the actuator 30 so as to satisfy the following conditions in the above Formula (6).
A: −3.00e⁻⁶
B: 4.66e⁻⁴
C: −2.79e⁻²
D: 1.07
E: 1.83

In this case, the droplet speed of the droplet 61 at the time of reaching the recording medium M is 3 [m/s] or more, and the droplet 61 can be made to stably land on the recording medium M.

More preferably, the head drive controller 8 drives the actuator 30 so as to satisfy the following conditions in the above Formula (6).
A: −2.06e⁻⁶
B: 3.19e⁻⁴
C: −1.91e⁻²
D: 7.14e⁻¹
E: 1.13

In this case, the droplet speed of the droplet 61 at the time of reaching the recording medium M is 5 m/s or more, and the droplet 61 can be made to more stably land on the recording medium M.

As described above, the inkjet head 100 of the present embodiment includes: the pressure chamber 22 filled with the ink 60; the actuator 30 that changes a pressure of the ink 60 filling the pressure chamber 22; the nozzle 51 that ejects the ink 60 filling the pressure chamber 22 by the actuator 30 being driven; and the communication channel (supply-side communication channel 23) that supplies the ink 60 to the pressure chamber 22, wherein the communication channel has the narrowed part 231 having a cross-sectional area perpendicular to the ejection direction of the ink 60 smaller than any other part in the communication channel, and
wherein Q_{C} that is a Q factor in the pressure chamber 22 calculated by using 5.7 mPa·s as a viscosity of the ink 60, 1,080 kg/m³ as a density of the ink 60, and 1,521 m/s as a value of a speed of a sound transmitted through the ink 60 satisfies Formula (1) below.

$${Q}_{C} \geq 0.0222 {S}_{r} - 17. 524 , \qquad Formula ( 1 )$$

Sᵣ: The cross-sectional area of the narrowed part perpendicular to the ejection direction of the ink

Since the droplet speed of the droplet 61 when the satellite droplet is generated at a position of 1 mm in the Z-axis negative direction from the opening 511 is 8 m/s or more, it is possible to suppress the generation of the satellite droplet and to stably eject the ink.

Further, in the inkjet head 100 of the present embodiment, the nozzle 51 has a substantially circular section perpendicular to the ejection direction of the ink 60, and has the tapered part 513 having a cross-sectional area perpendicular to the ejection direction decreasing monotonically from the pressure chamber 22 side where the pressure chamber 22 is provided toward the ejection port side where the ejection port (opening 511) of the nozzle 51 is provided.

Further, in the inkjet head 100 of the present embodiment, the nozzle 51 has the funnel part 512 and the tapered part 513, the funnel part 512 has a substantially circular section perpendicular to the ejection direction of the ink 60, and has a cross-sectional area perpendicular to the ejection direction decreasing monotonically from the pressure chamber 22 side where the pressure chamber 22 is provided toward the ejection port side where the ejection port of the nozzle 51 is provided, and the tapered part 513 is disposed closer to the ejection port than the funnel part 512 is in the ejection direction, has a substantially circular section perpendicular to the ejection direction, has a cross-sectional area perpendicular to the ejection direction decreasing monotonically toward the ejection direction, and has an inclination of the decrease in the cross-sectional area smaller than an inclination of the decrease in the cross-sectional area of the funnel part 512 perpendicular to the ejection direction.

The taper angle of the funnel part 512 is 40 degrees or more and 50 degrees or less, and the taper angle of the tapered part 513 is 3 degrees or more and 12 degrees or less.

The nozzle 51 having the above-described shape has better satellite performance than the nozzle 51 having a shape having the tapered part 513 only.

Further, in the inkjet head 100 of the present embodiment, the nozzle 51 has the straight part 514 disposed closer to the ejection port than the tapered part 513 is in the ejection direction, and the straight part 514 has a substantially circular section perpendicular to the ejection direction, and has a cross-sectional area perpendicular to the ejection direction not changing.

Further, the inkjet head 100 of the present embodiment includes the nozzle rows (rows L1 and L2) in each of which the nozzles 51 are arranged one dimensionally in a predetermined nozzle arrangement direction, wherein the nozzle rows are arranged such that the nozzles 51 of the nozzle rows are at same positions in the direction perpendicular to the relative movement direction with respect to the recording medium M at the time when drawing is performed while the ink 60 is ejected from the nozzles 51.

Therefore, droplet landing can be performed in a wide range in the movement direction of the recording medium M. That is, productivity of the inkjet recording apparatus 1 can be improved.

Further, the inkjet recording apparatus 1 of the present embodiment includes the inkjet head 100 and the drive controller (head drive controller 8) that drives the actuator 30, wherein the drive controller drives the actuator 30 such that the droplet speed of the ink 60 at a position of 0.5 mm in the ejection direction of the ink 60 from the ejection port of the nozzle 51 is 7 m/s or more.

Therefore, in the case where a media gap of 3 mm is set as a target, the droplet 61 can be made to land on the recording medium M as long as the volume of the droplet 61 is 1.2 pl or more.

Further, in the inkjet recording apparatus 1 of the present embodiment, in the case where the droplet speed at the position of 0.5 mm in the ejection direction from the ejection port is 7 m/s, the drive controller drives the actuator 30 by using the simple pull-and-strike waveform having a width of 1 AL such that a liquid measure of the droplet 61 of the ink 60 is 2 pL or more and 4 pL or less.

Therefore, it is possible to form the large droplet 611 by overlapping the droplets 61 which are the small droplets (2 pL or more and 4 pL or less), and even in the case where the media gap is large, to maintain good satellite performance.

Further, in the inkjet recording apparatus 1 of the present embodiment, the drive controller drives the actuator 30 by the drive waveform 70b having the first expansion portion 711, the second expansion portion 712 and the third expansion portion 713 that expand the volume of the pressure chamber 22 and the first contraction portion 721 and the second contraction portion 722 that contract the volume of the pressure chamber 22, and in the drive waveform 70b, the time from the start point of the second expansion portion 712 to the start point of the second contraction portion 722 is shorter than the time from the start point of the first expansion portion 711 to the start point of the first contraction portion 721.

Therefore, it is possible to prevent droplets from being formed by the second expansion portion 712 and the second contraction portion 722. In addition, it is possible to effectively pull back droplets by the second expansion portion 712 and the second contraction portion 722 and to appropriately advance the meniscus in the nozzle 51.

Further, in the inkjet recording apparatus 1 of the present embodiment, in the drive waveform 70b, the first contraction portion 721 is started 0.7 AL to 1.2 AL after the start point of the first expansion portion 711, the second expansion portion 712 is started 0.4 AL to 0.6 AL after the start point of the first contraction portion 721, the second contraction portion 722 is started 0.3 AL to 0.6 AL after the start point of the second expansion portion 712, and the third expansion portion 713 is started 0.8 AL to 1.2 AL after the start point of the second contraction portion 722.

Therefore, even in the case of high-speed driving (e.g., a drive period of 60 μs or less), ink can be stably ejected with small speed fluctuation of the droplet speed.

Further, in the inkjet recording apparatus 1 of the present embodiment, in the drive waveform 70b, the first contraction portion 721 is started 0.7 AL to 0.9 AL after the start point of the first expansion portion 711.

Therefore, the drive time can be further shortened.

Further, in the inkjet recording apparatus 1 of the present embodiment, the drive controller drives the actuator 30 by the composite drive waveform 70d including the first drive waveform W1 and the second drive waveform W2 applied after the first drive waveform W1, the first drive waveform W1 and the second drive waveform W2 each have the first expansion portion 711, the second expansion portion 712, the first contraction portion 721 and the second contraction portion 722, and the voltage amplitude AV2 of the second contraction portion 722 in the second drive waveform W2 is larger than the voltage amplitude AV1 of the second contraction portion 722 in the first drive waveform W1.

Therefore, it is possible to increase the speed of the droplet 61 of the ink 60 which is ejected by the second drive waveform W2, and it is possible to easily catch up with the droplet 61 of the ink 60 which is ejected earlier by the first drive waveform W1.

Further, in the inkjet recording apparatus 1 of the present embodiment, the composite drive waveform 70d includes, before the first drive waveform W1 being initial, the vibration waveform W0 that vibrates the liquid surface of the ink 60 in the nozzle 51.

Therefore, by vibrating the meniscus of the nozzle 51, it is possible to suppress change in the ejection characteristics of the ink due to drying (thickening) of the liquid surface of the ink.

Further, in the inkjet recording apparatus 1 of the present embodiment, the drive controller drives the actuator 30 such that the distance t_{gap} from the ejection port of the nozzle 51 to the recording medium M and the volume V_{drop} of the droplet 61 of the ink 60 satisfy Formula (2) below.

$${t}_{gap} \leq - 4.81 {{e}^{- 6} ( {V}_{drop} )}^{4} + 7.45 {{e}^{- 4} ( {V}_{drop} )}^{3} - 4.50 {{e}^{- 2} ( {V}_{drop} )}^{2} + 1.79 {V}_{drop} + 2 \text{.90} . \qquad Formula ( 2 )$$

Therefore, the droplet speed of the droplet 61 at the time of reaching the recording medium M in this case is 0.01 [m/s] or more, and the droplet 61 can be made to land on the recording medium M even in the case where the media gap is large.

The present invention is not limited to the above embodiment, and various modifications are possible.

For example, the above embodiment is described using an example in which the recording medium M is conveyed by the conveyor 3 including the conveyance belt 3b, but this is not a limitation, and the conveyor 3 may, for example, convey the recording medium M while holding it on the outer peripheral surface of a rotating conveyance drum.

Further, although the inkjet recording apparatus 1 of a single-pass type has been described as an example in each of the embodiments described above, the present invention may be applied to an inkjet recording apparatus that records an image while causing the inkjet head 100 to scan.

Although some embodiments of the present invention have been described, the scope of the present invention is not limited to the above-described embodiments, but encompasses the scope of the invention described in claims and the scope of equivalents thereof.

### INDUSTRIAL APPLICABILITY

The present invention can be applied to an inkjet head and an inkjet recording apparatus.

### REFERENCE SIGNS LIST

1 Inkjet Recording Apparatus
2 Controller
2a CPU
2b RAM
3 Conveyor
3a Conveyance Driver
3aa, 3ab Conveyance Roller
3b Conveyance Belt
4 Storage Section
4a Image Data
5 Communication Part
6 Display Part
7 Operation Reception Section
8 Head Drive Controller (Drive Controller)
8a Head Controller
8b Signal Controller
100A Head Unit
100Aa Base
100 Inkjet Head
10 Housing
11 Circuit Board
12 Head Base
13 Head Chip
20 Ink Ejection Channel
21 Supply Channel
22 Pressure Chamber
23 Supply-Side Communication Channel (Communication Channel)
231 Narrowed Part
24 Nozzle-Side Communication Channel
30 Actuator
30a Ink Supply Port
31 Pressure Chamber Layer
32 Vibration Plate
33 Insulating Layer
34 Piezoelectric Layer
35 Electrode Layer
40 Channel Substrate
50 Nozzle Substrate
51 Nozzle
51a Nozzle Opening Surface
511 Opening (Ejection Port)
512 Funnel Part
513 Tapered Part
514 Straight Part
60 Ink
61 Droplet
611 Large Droplet
62 Satellite Droplet
70a, 70b, 70c Drive Waveform
70d Composite Drive Waveform
711 First Expansion Portion
712 Second Expansion Portion
713 Third Expansion Portion
721 First Contraction Portion
722 Second Contraction Portion
A High-Speed Drive Region
M Recording Medium
W1 First Drive Waveform
W2 Second Drive Waveform

1. An inkjet head comprising:
a pressure chamber filled with ink;
an actuator that changes a pressure of the ink filling the pressure chamber;
a nozzle that ejects the ink filling the pressure chamber by the actuator being driven; and
a communication channel that supplies the ink to the pressure chamber,
wherein the communication channel has a narrowed part having a cross-sectional area perpendicular to an ejection direction of the ink smaller than any other part in the communication channel, and
wherein Q_{C} that is a Q factor in the pressure chamber calculated by using 5.7 mPa·s as a viscosity of the ink, 1,080 kg/m³ as a density of the ink, and 1,521 m/s as a value of a speed of a sound transmitted through the ink satisfies Formula (1) below:
$${Q}_{C} \geq 0.0222 {S}_{r} - 17. 524 , \qquad Formula ( 1 )$$
where Sᵣ represents, of the narrowed part, the cross-sectional area perpendicular to the ejection direction of the ink.

2. The inkjet head according to claim 1, wherein the nozzle has a substantially circular section perpendicular to the ejection direction of the ink, and has a tapered part having a cross-sectional area perpendicular to the ejection direction decreasing monotonically from a pressure chamber side where the pressure chamber is provided toward an ejection port side where an ejection port of the nozzle is provided.

3. The inkjet head according to claim 1,
wherein the nozzle has a funnel part and a tapered part,
wherein the funnel part has a substantially circular section perpendicular to the ejection direction of the ink, and has a cross-sectional area perpendicular to the ejection direction decreasing monotonically from a pressure chamber side where the pressure chamber is provided toward an ejection port side where an ejection port of the nozzle is provided, and
wherein the tapered part is disposed closer to the ejection port than the funnel part is in the ejection direction, has a substantially circular section perpendicular to the ejection direction, has a cross-sectional area perpendicular to the ejection direction decreasing monotonically toward the ejection direction, and has an inclination of the decrease in the cross-sectional area smaller than an inclination of the decrease in the cross-sectional area of the funnel part perpendicular to the ejection direction.

4. The inkjet head according to claim 3,
wherein a taper angle of the funnel part is 40 degrees or more and 50 degrees or less, and
wherein a taper angle of the tapered part is 3 degrees or more and 12 degrees or less.

5. The inkjet head according to claim 2,
wherein the nozzle has a straight part disposed closer to the ejection port than the tapered part is in the ejection direction, and
wherein the straight part has a substantially circular section perpendicular to the ejection direction, and has a cross-sectional area perpendicular to the ejection direction not changing.

6. The inkjet head according to claim 1, comprising nozzle rows in each of which nozzles each being the nozzle are arranged one dimensionally in a predetermined nozzle arrangement direction,
wherein the nozzle rows are arranged such that the nozzles of the nozzle rows are at same positions in a direction perpendicular to a relative movement direction with respect to a recording medium at a time when drawing is performed while the ink is ejected from the nozzles.

7. An inkjet recording apparatus comprising:
the inkjet head according to claim 1; and
a drive controller that drives the actuator,
wherein the drive controller drives the actuator such that a droplet speed of the ink at a position of 0.5 mm in the ejection direction of the ink from the ejection port of the nozzle is 7 m/s or more.

8. The inkjet recording apparatus according to claim 7, wherein in a case where the droplet speed at the position of 0.5 mm in the ejection direction from the ejection port is 7 m/s, the drive controller drives the actuator by using a simple pull-and-strike waveform having a width of 1 AL such that a liquid measure of a droplet of the ink is 2 pL or more and 4 pL or less.

9. The inkjet recording apparatus according to claim 7,
wherein the drive controller drives the actuator by a drive waveform having a first expansion portion, a second expansion portion and a third expansion portion that expand a volume of the pressure chamber and a first contraction portion and a second contraction portion that contract the volume of the pressure chamber, and
wherein in the drive waveform, a time from a start point of the second expansion portion to a start point of the second contraction portion is shorter than a time from a start point of the first expansion portion to a start point of the first contraction portion.

10. The inkjet recording apparatus according to claim 9, wherein in the drive waveform, the first contraction portion is started 0.7 AL to 1.2 AL after the start point of the first expansion portion, the second expansion portion is started 0.4 AL to 0.6 AL after the start point of the first contraction portion, the second contraction portion is started 0.3 AL to 0.6 AL after the start point of the second expansion portion, and the third expansion portion is started 0.8 AL to 1.2 AL after the start point of the second contraction portion.

11. The inkjet recording apparatus according to claim 10, wherein in the drive waveform, the first contraction portion is started 0.7 AL to 0.9 AL after the start point of the first expansion portion.

12. The inkjet recording apparatus according to claim 9,
wherein the drive controller drives the actuator by a composite drive waveform including a first drive waveform and a second drive waveform applied after the first drive waveform,
wherein the first drive waveform and the second drive waveform each have the first expansion portion, the second expansion portion, the first contraction portion and the second contraction portion, and
wherein a voltage amplitude of the second contraction portion in the second drive waveform is larger than a voltage amplitude of the second contraction portion in the first drive waveform.

13. The inkjet recording apparatus according to claim 12, wherein the composite drive waveform includes, before the first drive waveform being initial, a vibration waveform that vibrates a liquid surface of the ink in the nozzle.

14. The inkjet recording apparatus according to claim 7, wherein the drive controller drives the actuator such that a distance t_{gap} from the ejection port of the nozzle to a recording medium and a volume V_{drop} of a droplet of the ink satisfy Formula (2) below:
$${t}_{gap} \leq - 4.81 {{e}^{- 6} ( {V}_{drop} )}^{4} + 7.45 {{e}^{- 4} ( {V}_{drop} )}^{3} - 4.50 {{e}^{- 2} ( {V}_{drop} )}^{2} + 1.79 {V}_{drop} + 2 \text{.90} . \qquad Formula ( 2 )$$
